(19) United States
(12) Patent Application Publication
(10) Pub. No.: US 2017/0162032 A1
(43) Pub. Date: Jun. 8, 2017

(54) PERSONAL SECURITY

(71) Applicant: Blueforce Development Corporation, Newburyport, MA (US)

(72) Inventors: William S. Gellman, Duxbury, MA (US); Michael C. Helfrich, Salisbury, MA (US)

(21) Appl. No.: 15/360,172

(22) Filed: Nov. 23, 2016

Related U.S. Application Data
(60) Provisional application No. 62/263,323, filed on Dec. 4, 2015.

(51) Int. Cl. G08B 25/01; G08B 25/10

(52) U.S. Cl. CPC G08B 25/016; G08B 25/10

(57) ABSTRACT

A personal security system includes a personal security device which a user can use to call for help. The user triggers the device to go into a panic state by interacting with the device in particular ways, some of which are covert. Each interaction has a meaning which the device assigns a different meaning that signifies the user needs help. When in the panic state, the device can send a notification to a security node associated with the device; and the device can capture data (such as sounds and images) and send that data to the security node. The security node in turn can render aid based on this information. Advantageously, the user can call for help quickly, easily, and some instances discretely.

### CROSS-REFERENCE TO RELATED APPLICATION(S)

This application claims the benefit under 35 U.S.C. §119(e) of U.S. Provisional Application Ser. No. 62/263,323 filed on Dec. 4, 2015 the entire disclosure of which is incorporated herein by reference.

### TECHNICAL FIELD

The present invention relates to personal security and in particular to a personal security system that includes a personal security device having a panic state that can be triggered by a user.

### BACKGROUND

Today's technology provides us with public services (such as the 911 telephone number) for summoning emergency help. However, these services fall short in the case of a young child, a visiting allied health worker, a lone field worker, a mentally incompetent or medically incapacitated person, the victim of abduction or kidnapping or any individual that is in the middle of a violent crime or other situation that makes it difficult or impossible to use wired or wireless communication technologies to call for assistance.

Current technology around mobile personal security typically falls into two categories. Generally speaking, there are systems that leverage a dedicated device, in common parlance referred to as a “dongle,” as well as solutions that leverage mobile devices, typically cellular phones. A dongle is a dedicated device that can vary in form factor from a simple small keychain to something more feature-rich, which might be roughly the size of a cellular phone. The simple dongle has limited ability to communicate. Upon activation, the simple dongle just sounds an audible alarm and perhaps flashes some lights. Standard sound output can be in the neighborhood of 100-200 dB. Ostensibly, such a simple device works under the premise that the would-be attacker would leave the scene thinking that the noise will draw attention to their unlawful activities.

Another type of dongle is enabled with central monitoring. At the most basic level, this kind of dongle can communicate using either WIFI for an at-home only solution or a cellular network with a data plan for a mobile solution. The dongle when activated will notify a central monitoring center that there is an issue. The center will in turn use escalation rules to route assistance. Modern versions of the dongle can also provide a GPS location so that a dispatcher knows the general location of the person in distress. More advanced dongles can open a two-way audio channel to enable communication between the center and the person in panic. Yet, even these advanced dongles still have limited ability to communicate what is really going on around the victim, and may not have the ability to store and assemble “full chain of custody” data, which chronicles the event timeline.

Solutions that leverage mobile phones include an application that runs on a user's mobile phone. These solutions leverage the voice/data plan of the user's mobile phone to alert a pre-designated third party or parties to the user's situation. In the notification via electronic communication model, upon activation the mobile phone steps through a pre-arranged procedure. Typically, some combination of text messaging, email, or other electronic communication channel is used to notify a single person or a group of people that one is in a panic state. By leveraging GPS and mapping application programming interfaces (API's) of modern mobile phones, some of these mobile phone solutions can send a link to a URL as well so that a responder can view on a map the user's location at the time of panic. Still, many of these mobile phone applications do not leverage the full range of sensory data available from the mobile phone. This includes magnetometer data (i.e., direction of movement); atmospherics (i.e., the signals detected by the mobile phone); accelerometer data (i.e., is the mobile phone moving or still); imagery (i.e., static and/or full motion video, live and/or captured and forwarded) and live streaming multimedia, such as voice and video.

In the call center monitoring model, upon triggering a mobile phone application into a panic state, a third party monitoring installation is notified and an escalation plan is put into place to route the appropriate aid. The value add of these systems seems to be predominantly based on location service made possible by the innate GPS ability of the mobile phone and the communication ability derived from the voice and/or data plans on the mobile phone.

### SUMMARY

Unfortunately, we are constantly reminded of the need for personal safety and security in today's world. Much attention has been given to mass shootings but also consider a nurse visiting a patient who may be violent, a contractor installing solar panels on a high rooftop or a traveling mechanic fixing a car on the side of a desolate road. In all these situations and many others, there is need for a personal security system that travels with the individual and is able to define and signal an emergency situation without user intervention. Further, there is a need for a personal security system to convey potentially valuable information, such as a voice message, an image and/or a movie/video. Such information could be useful in identifying the location of the emergency or determining what type of emergency response is appropriate (e.g., police, ambulance, and fire).

Accordingly, a personal security system is provided as a safety net for those who require personal safety and protection or work in remote and potentially hazardous environments. The system includes a personal security device which a user can use to initiate a call for help. The call for help can include the type of emergency (e.g., violence, health, or disciplinary). The call for help can be used by the user to check-in and check-out with someone who is responsible for their safety. The personal security device can also capture and send device initiated data, including location, signal/atmospherics, imagery, and live streaming audio to other people, local monitoring, and/or central monitoring services.

An exemplary personal security system includes a personal security device and a security node in association with the device. The personal security device monitors a user's interaction with the personal security device, which has a first meaning. The personal security device assigns a second meaning to the user's interaction that is different than the first meaning. The assigned second meaning signifies that the user needs assistance. Based on the second meaning of the user's interaction with the personal security device, the personal security device changes its state to the panic state. In response to the state change, the personal security device can collect data captured by the personal security device and send it to the security node. Alternatively (or in combination), the personal security device can send a panic notification to the associated security node.

The user's interactions being monitored by the personal security device can include any one of the following: the user removing a plug from a headphone jack on the personal security device; and the user depressing and holding down a volume up/down toggle bar on the personal security device. The monitored interactions can also be the user moving the personal security device within range or out of range of a wireless device, which can be a wearable or nearable device in wireless communication with the personal security device. In other examples, the monitored interactions can include the user's manipulation of a wearable or nearable device in wireless communication with the personal security device.

The device data being collected and sent to the security node can include any one of the following: a recording captured by a microphone associated with the personal security device; a still photograph and/or video captured by a camera associated with the personal security device; attitude and motion captured by a gyroscope associated with the personal security device; heading captured by a magnetometer associated with the personal security device; and information in broadcast signals received by an antenna associated with the personal security device. The collected data can also be environmental information, physiologic data of the user or a combination of such information detected by a sensor(s) associated with the personal security device, electronically.

The panic notification sent by the personal security device can indicate the type of emergency is violence, disciplinary, health or a custom panic condition defined by someone who is responsible for the user's security. The panic notification can also indicate whether the user is checking in or checking out with the security node. The panic notification can be sent as a text message, a Short Message Service message, an email, Extensible Messaging and Presence Protocol message or other communication protocol suitable for transmitting data between devices.

The security node can be an autonomous agent or a human dispatcher. The security node can send a command to the personal security device to control what data is being collected and sent by the personal security device. The personal security device and the security node can be communicatively coupled by way of a personal security network. The personal security device can be wirelessly coupled to the personal security network.

### BRIEF DESCRIPTION OF THE DRAWINGS

The foregoing and other objects, features, and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a block diagram of an example of a personal security system for providing personal safety.

FIGS. 2A and 2B are flow charts of example processes for providing personal safety.

FIG. 3 is a block diagram of an example personal security device with a personal security engine.

### DESCRIPTION

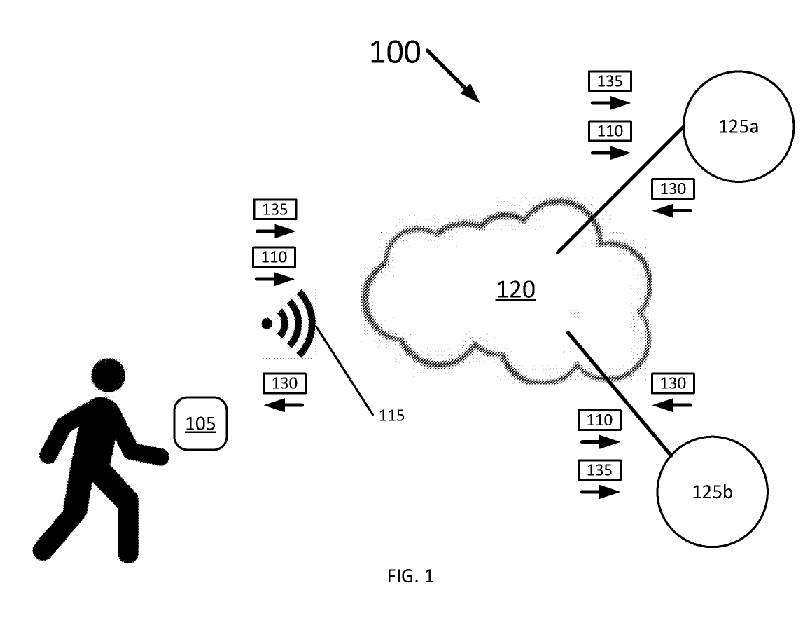

The invention relates to a personal security system for providing personal security or safety to a user. FIG. 1 shows an example personal security system 100 in which a user carries a personal security device 105. When there is an emergency and the user needs help, the user can trigger the personal security device 105 to go into a “panic state”. Alternatively, the personal security device 105 can sense that the user needs help and goes into the panic state by itself.

The personal security device 105 sends a panic notification 110 over a wireless connection 115 to a personal security network 120. Attached to the personal security network 120 is an autonomous agent 125a and/or a human dispatcher 125b, collectively referred to as a “security node” 125, who is monitoring the user. The security node 125 receives the panic notification 110 and can provide the user with assistance, e.g., alerting the police or other emergency personnel.

The wireless connection 115 between the personal security device 105 and the security node 125 can be established using 3G/4G/LTE/FirstNet, WIFI, WiMAX, satellite, and/or mobile ad-hoc networks, just to name a few wireless communication technologies. The wireless connection 115 can be secured using a “subscription process” and/or an “encryption process” described in U.S. Pat. Nos. 8,467,779; 8,682,309; and 9,066,211, which are incorporated in their entirety herein. The security node 125 can send a security node message 130 to the personal security device 105 with a command instructing the personal security device 105 to take further action (as will be described in greater detail below).

The panic notification 110 can include an indication of the type of emergency, such as violence, health or disciplinary, which can be used by the security node 125 to provide appropriate assistance. For example, in the context of a school or campus a panic notification with an emergency type of disciplinary signals a policeman is needed while another panic notification with an emergency type of violence signals a specialized law enforcement unit is needed. The emergency type can be a custom panic condition defined by an organization or company, who is responsible for the user's security. Beneficially, a set of custom panic conditions can be defined that are tailored to particular threats the user is likely to encounter. The emergency type can be configured on the personal security device 105 (e.g., through a settings menu) or in response to a trigger as will be described below.

The panic notification 110 can be used to check-in/checkout with someone who is responsible for a user's safety. For example, a user on a blind date can request a regular check-in or monitoring of their current location with respect to a planned itinerary. This “follow me” feature is particular advantageous when a user is in an unfamiliar setting and mitigates the threat of rape, assault, robberies, etc. The panic notification can be sent as a text message, a Short Message Service message, an email, an Extensible Messaging and Presence Protocol message or other communication protocol suitable to transmit data between devices, electronically.

In the panic state, the personal security device 105 can collect data captured by one or more sensors associated with the personal security device 105 and send the collected data to the security node 125 in a user message 135 (as will be described below in greater detail). The security node 125 can then use the data to provide assistance to the user. Advantageously, the collected data can chronicle the emergency and provide full chain of custody data that can be used as forensic evidence.

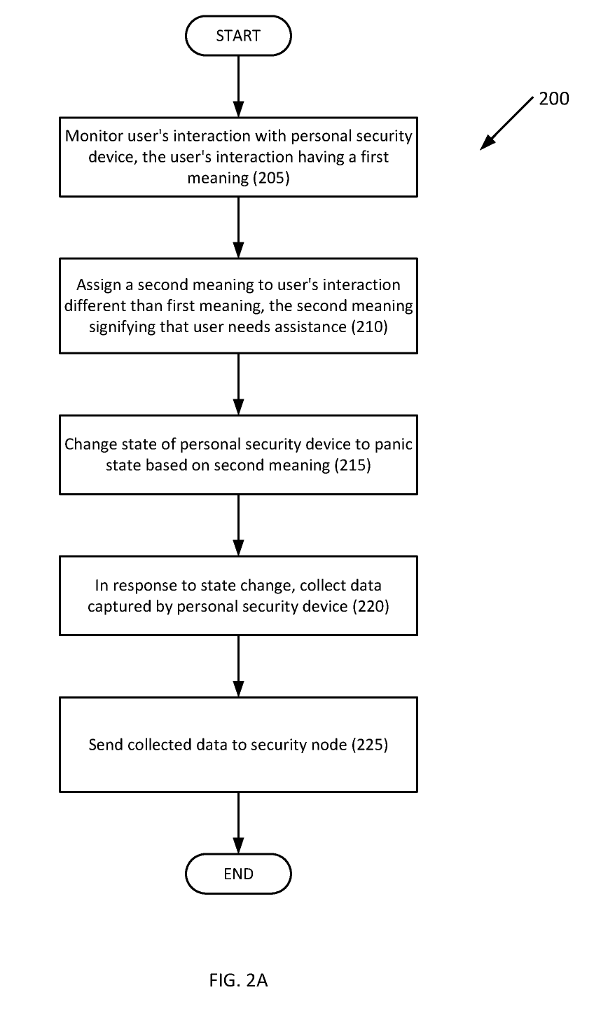

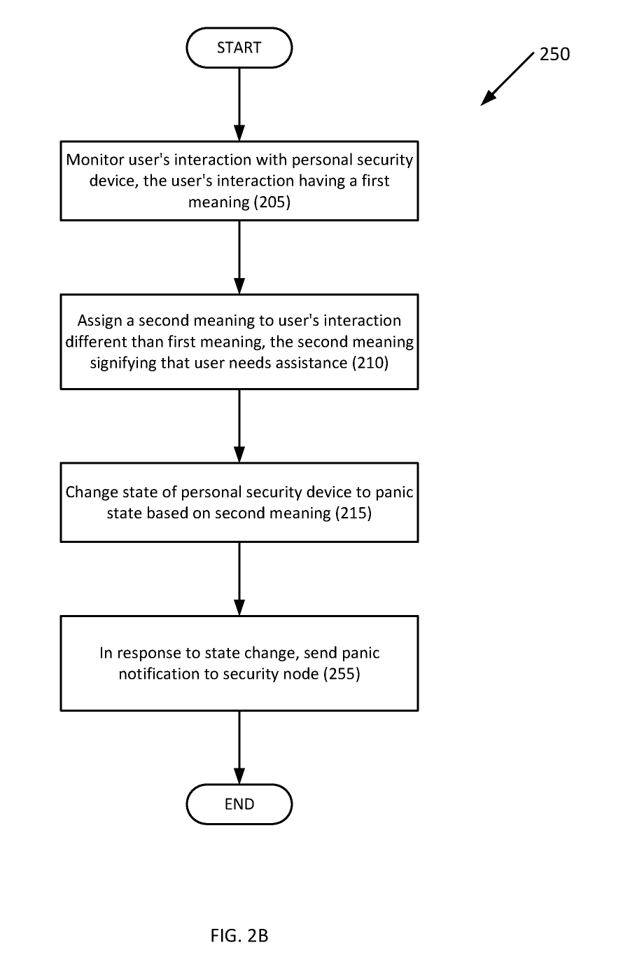

FIG. 2A shows an example process 200 for providing personal safety. The process 200 is described with reference to FIG. 1. The process 200 starts and monitors (205) the user's interaction with the personal security device 105. The user's interaction has a first meaning. The process 200 assigns (210) a second meaning to the user's interaction that is different than the first meaning. The second meaning signifies that the user needs assistance. For example, a user unplugging a standard set of headphones from the personal security device 105 can mean the user is done listening to music (a first meaning). In an emergency situation, the same act of unplugging headphones has another meaning; the user needs help (a second meaning). Assigning a different meaning is advantageous because an act of calling for help can be hidden so as not to draw attention to the act, which can actually make the situation worse. Such a “covert” call for help can be contrasted with an overt action like dialing 911.

Continuing with the process 200, based on the second meaning of the user's interaction with the personal security device 105, the process 200 changes (215) a state of the personal security device 105 to the panic state. In response to the state change, the process 200 collects (220) data captured by the personal security device 105. The process 200 sends (225) the collected data to the security node 125 (e.g., as the user message 110 of FIG. 1), and the process 200 ends.

FIG. 2B shows another example process 250 for providing personal safety, which differs from the process 200 described above. The processes 200 and 250 share steps 205 through 215 and, as such, these steps will be not described again for the sake of brevity. The process 250 in response to the change to the panic state; sends a panic notification (e.g., the panic notification 135 of FIG. 1.). The process 250 ends. It should be understood that the processes 200 and 250 can be combined, i.e., in the panic state, the personal security device 105 sends both the collected data and the panic notification. It may be convenient to say that the steps of monitoring the user's interaction and assigning a second different meaning to the user's interaction (steps 205 and 210, respectively) “triggers” the personal security device 105 into the panic state. Below are examples of different ways the personal security device 105 can be triggered into the panic state.

As described above, the personal security device 105 can be triggered into a panic state through the removal of a set of headphones. The headphones plug into a jack (or port) on the personal security device 105. The jack can be a small round connector for accepting a pin-shaped plug from a standard pair of music headphones. Common sizes for the jack include 2.5 mm and 3.5 mm. The jack can support stereo sound and/or a microphone, depending on the number of separate connector rings on the plug or jack.

In other examples, the personal security device 105 can be triggered by pulling on a lanyard or other device attached to a plug to remove it from the personal security device 105. This “rip cord” approach to triggering the panic state can include arming/disarming (activating/deactivating) the feature so that the personal security device 105 is responsive/unresponsive to such action. This useful when the user wants to unplug the headphones without triggering the panic state.

The personal security device 105 can be triggered into a panic state by depressing and holding down volume up/down buttons (or toggle bar) on the personal security device 105. The duration for holding down or “mashing” the volume up/down buttons can be configured. For example, if the volume down is depressed for at least 5 seconds, the panic state is triggered. Holding down the volume down for less than 5 seconds does not trigger the personal security device 105 into the panic state. This useful because it allows the user to continue using the volume up/down buttons to control the volume as they normally would and when necessary use them to call for help.

The personal security device 105 can be wirelessly connected to a “wearable” or “nearable” device, for example using BLUETOOTH, ZIGBEE, and ZWAVE just to name a few wireless protocols. The wearable device can include clothing and accessories incorporating computer and advanced electronic technologies (e.g., a fitness tracker worn around the wrist). A nearable device is an electronic device having one or more sensors (such as an accelerometer and temperature sensor) and a radio (such as BLUETOOTH Smart radio) for transmitting digital data. The nearable device can be attached to everyday things like a classroom desk turning it into a smart object. The data transmitted by the nearable device can include the following information: is the thing to which the nearable device is attached in motion (and for how long), is the thing to which the nearable device is attached still (and for how long), raw X, Y, Z accelerometer readings, temperature, broadcasting power (which can used to calibrate proximity estimations), and battery voltage (which can be used to estimate the battery level of the nearable device). An example of the nearable device includes ESTIMOTE stickers developed by ESTIMOTE of New York.

The range of a wireless connection between the personal security device 105 and the wearable/nearable device is limited. The panic state can be triggered when the person security device 105 is within range of the wearable/nearable device (proximity) and establishes the wireless connection. Alternatively, the panic state can be triggered when the person security device 105 is out of range of the wearable/nearable device (distance) and the personal security device 105 loses the wireless connection with the device. This is beneficially because the personal security device 105 can be triggered into the panic state, automatically, based on the proximity or distance of the personal security device 105 to the wearable/nearable device.

Advantageously, the personal security device 105 can be configured to go into the panic state when it is close to a first device and when it is far from a second device. For example, the area around a house is equipped with a “house alarm” and the area around a nearby pool is equipped with a “pool alarm”. When a child carrying the personal security device 105 wanders off out of range of the house alarm, the personal security device 105 loses its wireless connection with the house alarm. This triggers the panic state and a parent is notified that their child has wandered off and needs assistance. When the child enters the pool area in range of the pool alarm, the personal security device 105 establishes a wireless connection with the pool alarm. This triggers the panic state and the parent is notified that their child is in the pool area and needs assistance.

The personal security device 105 can be associated with one or more motion sensors for the detecting user movement or lack of movement. For example, the personal security device 105 is equipped with an internal gyroscope for sensing the orientation of the personal security device 105 and an accelerometer for measuring the force of acceleration, whether caused by gravity or by movement. Given this internal configuration, the personal security device 105 can detect user movement (or lack of) when being carried by the user.

The panic state can be triggered by either motion detected by the motion sensor(s) or the lack of motion. For example, a person carrying the personal security device 105 is moving about, and then all the sudden they fall and cannot get up. The motion sensors stop detecting the person's movement. This triggers the panic state and a care giver is notified that the person has fallen and needs assistance.

The personal security device 105 can be associated with a tracking band(s) worn around the user's wrist(s). As the user makes a gesture with their hand(s)/arm(s), the tracking band(s) detects/measures motion and attitude of the user's wrist(s). The personal security device 105 receives and interprets the gesture information from the tracking band(s). The personal security device 105 can then be triggered into the panic state based on the interpreted information.

The personal security device 105 can be triggered into the panic state by as sensor or device wirelessly connected to the personal security device 105 using BLUETOOTH, ZIGBEE, and ZWAVE just to name a few wireless protocols. For example, the sensor/device is a “button” covertly or overtly placed on the user's person that when depressed, triggers the personal security device 105, to which the button is connected to trigger the panic state. In another example, the user can trigger the panic state of the personal security device 105 by pushing button(s), touching or otherwise manipulating a device worn by the user (or a proximal device) that is wirelessly connected to the personal security device 105.

The personal security device 105 can be equipped with a touch screen displaying a virtual panic button. The user manipulates the virtual panic button to trigger the panic state. For example, the user slides (or swipes) the virtual panic button from a first position to a second position triggering the personal security device 105 into the panic state. The personal security device 105 can be equipped with a physical panic button or a programmable hardware button configured to be the panic button. In this example, the user pushes the panic button (e.g., a single push, multiple pushes or depressing the button for a pre-determined duration of time) to trigger the panic state.

The personal security device 105 can respond to the panic state by taking one or more actions, referred to as “internal actions.” In the panic state, the personal security device 105 collects data that may be helpful or even critical to providing the user with assistance. The personal security device 105 sends the data to the security node 125. The personal security device 105 can send the data to the security node 125 on a continual basis at preset intervals. Below are some examples of data that can be collected and sent by the personal security device 105.

The personal security device 105 can be equipped with or otherwise associated with a microphone for recording sound. In the panic state, the personal security device 105 turns on the microphone and records any speech or noises being made around the personal security device 105. This “listen live” feature is beneficial because such a recording provides an aural account of what the user is experiencing and the situation they are in that can help others provide assistance to the user. For example, the personal security device 105 in the panic state records a bell in a clock tower ringing. This information can be used to locate the user even when GPS coordinates are not available. The data collected can also be persisted audio so as to form a permanent aural account of the user's experience.

The personal security device 105 can include one or more cameras for taking still pictures/images and/or recording video. In the panic state, the personal security device 105 collects picture(s) captured by the camera and sends the picture(s) at preset intervals (e.g., one picture every thirty seconds, two pictures every thirty seconds, etc.). This “camera autofire”, feature is beneficial because it provides a visual account of what the user is experiencing and the situation they are in that can help others provide assistance to the user. For example, the personal security device 105 in the panic state captures a series of pictures of the roadside passing by. This information can be used to identify what road and in which direction the user is being taken.

The personal security device 105 can be equipped with or otherwise associated with an accelerometer, gyroscope, magnetometer or combination of them. In the panic state, the personal security device 105 collects and sends the force of acceleration measured by the accelerometer, the orientation of the personal security device 105 sensed by the gyroscope or the heading sensed by the magnetometer. Provided with this information or combination of information, the security node 125 can know what is going on with the user and their situation, and can provide the user with assistance. For example, acceleration, origination, and heading information collected and sent by the personal security device 105 in the panic state can be used to estimate the position and speed of the user. The estimations in turn can be used to locate the user even when GPS coordinates are not available.

The personal security device 105 can be fused to or communicating with worn, carried or proximal sensors/devices that provide environmental information (such as temperature, humidity, air quality, gasses or radioactivity present in the proximal environment to name a few) or physiologic data of the wearer (such as heart rate, skin temperature, galvanic skin response to name a few). The personal security device 105 can be fused with such sensors according to U.S. Pat. Nos. 8,467,779; 8,682,309; and 9,066,211, which are incorporated in their entirety herein. The personal security device 105 can collect the environmental information and/or physiologic data of the wearer and send it to the security node 125. Such information (alone or combined with other information) can provide situation awareness needed to provide aid to the user.

The personal security device 105 can include one or more antennas for receiving wireless signals being broadcasted, such as cellular radio, WIFI, BLUETOOTH, ZIGBEE, and ZWAVE just to name a few wireless signals. Cell towers, base stations, and public WIFI access points (just to name a few) broadcast signals that can include location and/or time information as well as other metadata. For example, a cellular tower broadcasts a cellular radio signal that includes the location of the tower. Devices receiving the broadcasted signals can use the information to establish a wireless connection, for example. The personal security device 105 in the panic state collects and sends this “atmospheric” information to the security node 125. This feature of collecting and sending atmospheric data is beneficial because it can be used to locate the user even in a GPS denied situation, such as inside a car trunk.

The personal security device 105 can preprogrammed to send text messages, such as Short Message Service (SMS) messages, to one or more preset phone numbers when the personal security device 105 is in the panic state. Recipients of the text message are then alerted that the personal security device 105 is in the panic state and that the user needs assistance. Advantageously, the user can call for help, automatically, without having to dial up a recipient and write a text messages. Furthermore, with this approach, a text message can be sent to multiple recipients, such as an emergency contact and police.

Upon detecting that the personal security device 105 is in the panic state, the security node 125 can take various actions referred to as “external actions.” As described above, the security node 125 can include the autonomous agents 125a and the human dispatcher 125b. The external action that can be taken by each kind of security node is described below in turn.

One or more autonomous agents can be subscribed to the personal security device 105 in accordance with the subscription process described in U.S. Pat. Nos. 8,467,779; 8,682,309; and 9,066,211, which are incorporated in their entirety herein. The agents upon receiving the panic notification 110 and/or data collected by the personal security device 105 (as described above) are capable of taking a number of different actions, including escalation. The autonomous agent can be programmed with logic that provides them the ability to escalate a panic situation using pre-set procedures. These procedures govern the actions the agents take and can include the following:

Notify additional people, other autonomous agents: The agent can be programmed to send SMS, email, or use other similar communications protocols to inform people or other systems (such as the BLUEFORCEEDGE developed by BLUEFORCE DEVELOPMENT of Newburyport, Mass.).

Call Center: The agent can route the panic notification/collected data to a third party emergency call center. The routing can be accomplished by writing to the center's application program interface (API) and integrating with an emergency monitoring infrastructure. This could be a public emergency system, such as public safety dispatch or a commercial concern, which then uses its own escalation protocols to mitigate the situation and render aid.

The personal security system 100 allows the human dispatcher 125b to monitor personal security devices to which they are subscribed using a human interface endpoint. Example human interface endpoints include BLUEFORCE COMMAND CENTER and BLUEFORCE TACTICAL developed by BLUEFORCE DEVELOPMENT of Newburyport, Mass. The human interface endpoint can be implemented by computers or smart mobile devices and is capable of using various methods for notifying human users and displaying relevant information to them. The human interface endpoint can do one or more of the following when it receive the panic notification 110 and/or data collected by the personal security device 105, as described above.

Show geo-location: The human interface endpoint shows the location of the personal security device 105 in the panic state on a map. It can also show the track where the personal security device 105 has been over various timeframes preceding the panic trigger.

Shows Panic Status: The personal security device 105 is shown as being in a panic state using color cues and symbols.

Provides access to data collected by a personal security device in panic mode: The human interface endpoint allows for organized viewing of data collected by the personal security device 105 in the panic state. The collected data provides the human dispatcher 125b (who can include team members, command structure, incident commanders, etc.) with situational awareness for determining how best to render aid.

Provide remote control of a personal security device in panic mode: The human dispatcher 125b using the human interface endpoint can remotely control the personal security device 105 in the panic state. They can send commands to turn on/off the internal actions described above that are taken by the personal security device 105. For example, they can send a command is turn on a microphone associated with the personal security device 105 and record what is going on.

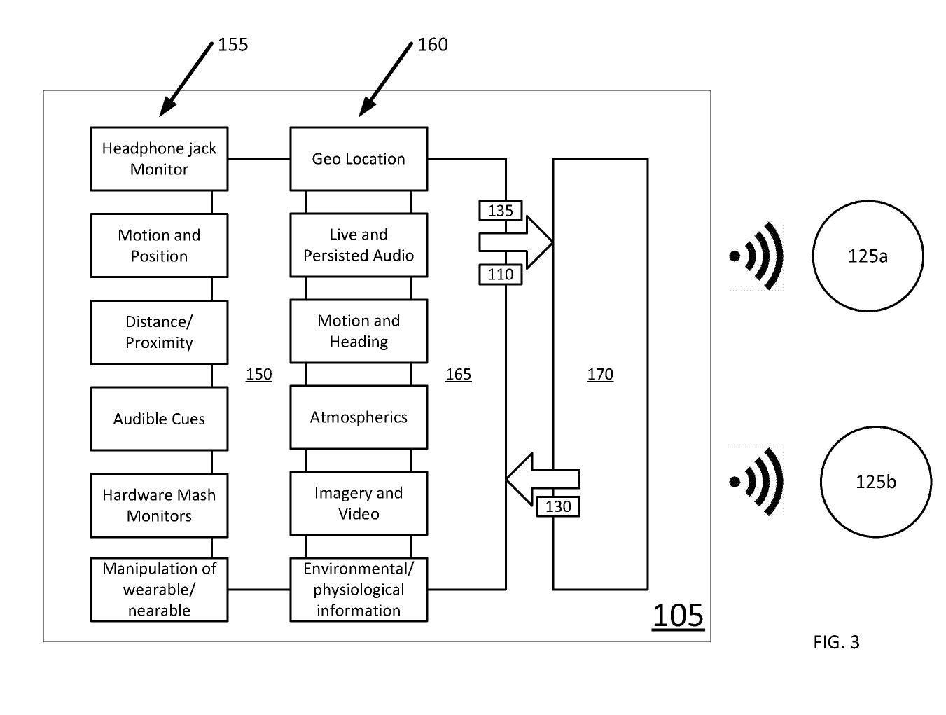

FIG. 3 shows the personal security device 105 with a personal security engine 150 for performing the personal security functionalities described above. The personal security engine 150 responds to triggers 155 by going into the panic state as described above. In the panic state, the personal security engine 150 collects data 160, as described above as internal actions.

The personal security engine 150 is communicatively coupled to a message handler 165. The message handler 165 packs the collected data 160 into the user message 135, which is then sent to a security node, such as the autonomous agent 125a and the human dispatcher 125b. The message handler 165 can also unpack the security node message 130 received from the autonomous agent 125a or the human dispatcher 125b. Commands for remotely controlling the personal security device 105 (e.g., to take pictures and record audio) can be sent inside the security node message 130. The message handler 165 can also coordinate the sending of the panic notification 110 in response to the triggers 155.

The message handler 165 is further communicatively coupled to a security module 170. The security module 170 encrypts messages sent to a security node and decrypts messages received from a security node. The security module 170 can carry out the encryption process described in U.S. Pat. Nos. 8,467,779; 8,682,309; and 9,066,211, which are incorporated in their entirety herein.

The security module 170 can also provide secure transport layer services for communications between the personal security device 105 and a security node. The services can include measures beyond the native Internet Protocol security inherent in any connectivity networks in order to keep transfers of data confidential and to prevent unauthorized access to any data exchanged. In some examples, the security module 170 provides data exchanges that are compliant with the Health Insurance Portability and Accountability Act (HIPAA). For increased security, the security module 170 can perform the subscription process described in U.S. Pat. Nos. 8,467,779; 8,682,309; and 9,066,211, which are incorporated in their entirety herein.

The personal security device 105 can be a smart phone, a smart watch, a tablet or other mobile computing device (with or without a display). The personal security device 105 can be a device that is carried, worn or otherwise transported near a person. All of these and other examples, have a processor and computer readable storage containing processor-executable instructions as well as data, files, etc. These instructions when executed by the processor cause the personal security device 105 to perform the functions of the personal security engine 150 as described above. The personal security device 105 typically has an operating system such as a MICROSOFT, APPLE, ANDROID, BLACKBERRY, ANDROID WEAR or LINUX operating system. The computer readable storage can be, but not limited to, any type of disk including floppy disks, optical disks, CD-ROMs, magnetic optical disks, read-only memories (ROMs), random access memories (RAMs), EPROMs, EEPROMs, magnetic or optical cards, application specific integrated circuits (ASICs), or any other type of non-transitory storage medium suitable for storing processor-executable instructions.

Various aspects and functions described herein, such as the autonomous agents 125a and the human interface endpoint used by the human dispatcher 125b, can be implemented as specialized hardware or software components executing in one or more computer systems. There are many examples of computer systems that are currently in use. These examples include, among others, network appliances, personal computers, workstations, mainframes, networked clients, servers, media servers, application servers, database servers, and web servers. Other examples of computer systems may include mobile computing devices, such as cellular phones and personal digital assistants, and network equipment, such as load balancers, routers, and switches. Further, aspects may be located on a single computer system or may be distributed among a plurality of computer systems connected to one or more communications networks.

For example, various aspects, functions, and processes may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, embodiments are not limited to executing on any particular system or group of systems. Further, aspects, functions, and processes may be implemented in software, hardware or firmware, or any combination thereof. Thus, aspects, functions, and processes may be implemented within methods, acts, systems, system elements and components using a variety of hardware and software configurations, and examples are not limited to any particular distributed architecture, network, or communication protocol.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

The invention may be embodied in other specific forms without departing from the spirit or essential characteristics thereof. The foregoing examples are therefore to be considered in all respects illustrative rather than limiting of the invention described herein. Also, the words comprise, include, and/or plural forms of each are open ended and include the listed parts and can include additional parts or steps that are not listed, and the term and/or is open ended and includes one or more of the listed parts or steps and combinations of the listed parts steps.

1. A method for providing personal security, the method comprising:
in a personal security device having a panic state and being in wireless communication with a personal security system having at least one security node in association with the personal security device, the personal security device monitoring a user's interaction with the personal security device, the user's interaction having a first meaning;
assigning a second meaning to the user's interaction different than the first meaning, the second meaning signifies that the user needs assistance;
changing a state of the personal security device to the panic state based on the second meaning of the user's interaction with the personal security device;
in response to the change, collecting data captured by the personal security device; and
sending the collected data to the associated security node.

2. The method of claim 1, wherein the user's interaction being monitored includes any one of: the user removing a plug from a headphone jack on the personal security device; the user depressing and holding down a volume up/down toggle bar on the personal security device; the user moving the personal security device within range of a wireless device; and the user moving the personal security device out of range of a wireless device.

3. The method of claim 2, wherein the wireless device is any one of wearable and nearble devices.

4. The method of claim 1, wherein the user's interaction being monitored includes the user manipulating a wearable or nearable device in wireless communication with the personal security device.

5. The method of claim 1, wherein collecting the data includes collecting any one of: a recording captured by a microphone associated with the personal security device; a still photograph and/or video captured by a camera associated with the personal security device; attitude and motion captured by a gyroscope associated with the personal security device; heading captured by a magnetometer associated with the personal security device; and information in broadcast signals received by an antenna associated with the personal security device.

6. The method of claim 1, wherein collecting the data includes collecting any one of environmental information, physiologic data of the user, and combination thereof detected by a sensor associated with the personal security device.

7. The method of claim 1, further comprising receiving from the security node, a command controlling the data collection.

8. A method for providing personal security, the method comprising:
in a personal security device having a panic state and being in wireless communication with a personal security system having at least one security node in association with the personal security device, the personal security device monitoring a user's interaction with the personal security device, the user's interaction having a first meaning;
assigning a second meaning to the user's interaction different than the first meaning, the second meaning signifies that the user needs assistance;
changing a state of the personal security device to the panic state based on the second meaning of the user's interaction with the personal security device; and
in response to the change, sending a panic notification to the associated security node.

9. The method of claim 8, wherein the user's interaction being monitored includes any one of: the user removing a plug from a headphone jack on the personal security device; the user depressing and holding down a volume up/down toggle bar on the personal security device; the user moving the personal security device within range of a wireless device; and the user moving the personal security device out of range of a wireless device.

10. The method of claim 9, wherein the wireless device is any one of wearable and nearble devices.

11. The method of claim 8, wherein the user's interaction being monitored includes the user manipulating a wearable or nearable device in wireless communication with the personal security device.

12. The method of claim 8, wherein sending the panic notification indicating the personal security device is in the panic state includes sending any one of a text message, a Short Message Service message, an email, and Extensible Messaging and Presence Protocol message.

13. The method of claim 8, wherein sending the panic notification includes indicating the type of emergency is any one of violence, disciplinary, health, and a custom panic condition defined by someone who is responsible for the user's security.

14. The method of claim 8, wherein sending the panic notification includes indicating the user is checking in or checking out with the security node.

15. The method of claim 8 further comprising:
collecting data captured by the personal security device; and
sending the collected data to the security node.

16. The method of claim 15, wherein the data being collected is captured by a sensor associated with the personal security device.

17. The method of claim 15 further comprising receiving from the security node, a command controlling the data collection.

18. A system for providing personal security, the system comprising:
a personal security device configured to:
monitor a user's interaction with the personal security device, the user's interaction having a first meaning;
assign a second meaning to the user's interaction different than the first meaning, the second meaning signifies that the user needs assistance;
change a state of the personal security device to the panic state based on the second meaning of the user's interaction with the personal security device;
in response to the change, collect data captured by the personal security device; and
send the collected data; and
a security node in association with the personal security device, the security node configured to receive the collected data from the personal security device and provide the user with assistance.

19. The system of claim 18, wherein the personal security device is configured to monitor the user's interaction including any one of: the user removing a plug from a headphone jack on the personal security device; the user depressing and holding down a volume up/down toggle bar on the personal security device; the user moving the personal security device within range of a wireless device; and the user moving the personal security device out of range of a wireless device.

20. The system of claim 19, wherein the wireless device is any one of wearable and nearble devices.

21. The system of claim 18, wherein the personal security device is configured to monitor the user's interaction including the user manipulating a wearable or nearable device in wireless communication with the personal security device.

22. The system of claim 18, wherein the personal security device is configured to collect the data including any one of: a recording captured by a microphone associated with the personal security device; a still photograph and/or video captured by a camera associated with the personal security device; attitude and motion captured by a gyroscope associated with the personal security device; heading captured by a magnetometer associated with the personal security device; and information in broadcast signals received by an antenna associated with the personal security device.

23. The system of claim 18, wherein the personal security device is configured to collect the data including any one of environmental information, physiologic data of the user, and combination thereof detected by a sensor associated with the personal security device.

24. The system of claim 18, wherein the security node is any one of autonomous agent and human dispatcher.

25. The system of claim 18, wherein the security node is configured to send a command to the personal security device to control data collection by the personal security device.

26. The system of claim 18 further comprising a personal security network to which the personal security device and the security node are communicatively coupled.

27. The system of claim 26, wherein the personal security device is wirelessly coupled to the personal security network.

28. A system for providing personal security, the system comprising:
a personal security device configured to:
monitor a user's interaction with the personal security device, the user's interaction having a first meaning;
assign a second meaning to the user's interaction different than the first meaning, the second meaning signifies that the user needs assistance;
change a state of the personal security device to the panic state based on the second meaning of the user's interaction with the personal security device; and
in response to the change, send a panic notification to the associated security node;
a security node in association with the personal security device, the security node configured to receive the collected data from the personal security device and provide the user with assistance.

29. The system of claim 28, wherein the personal security device is configured to monitor the user's interaction including any one of: the user removing a plug from a headphone jack on the personal security device; the user depressing and holding down a volume up/down toggle bar on the personal security device; the user moving the personal security device within range of a wireless device; and the user moving the personal security device out of range of a wireless device.

30. The system of claim 29, wherein the wireless device is any one of wearable and nearble devices.

31. The system of claim 28, wherein the personal security device is configured to send the panic notification indicating the personal security device is in the panic state as any one of a text message, a Short Message Service message, an email, and Extensible Messaging and Presence Protocol message.

32. The system of claim 28, wherein the personal security device is configured to send the panic notification indicating the type of emergency is any one of violence, disciplinary, and health.

33. The system of claim 28, wherein the personal security device is configured to send the panic notification indicating the user is checking in or checking out with the security node.

34. The system of claim 28, wherein the personal security device is further configured to:
collect data captured by the personal security device; and
send the collected data to the security node.

35. The system of claim 34, wherein the data being collected is captured by a sensor associated with the personal security device.

36. The system of claim 34, wherein the security node is configured to send a command to the personal security device to control data collection by the personal security device.

37. The system of claim 28, wherein the security node is any one of autonomous agent and human dispatcher.

38. The system of claim 28 further comprising a personal security network to which the personal security device and the security node are communicatively coupled.

39. The system of claim 38, wherein the personal security device is wirelessly coupled to the personal security network.
